(19) United States
(12) Patent Application Publication
(10) Pub. No.: US 2015/0332353 A1
(43) Pub. Date: Nov. 19, 2015

(54) Methods and Systems of Authenticating Reviews

(71) Applicant: MASTERCARD INTERNATIONAL INCORPORATED, Purchase, NY (US)

(72) Inventor: Rohit Chauhan, Somers, NY (US)

(73) Assignee: MASTERCARD INTERNATIONAL INCORPORATED, Purchase, NY (US)

(21) Appl. No.: 14/277,345

(22) Filed: May 14, 2014

(51) Int. Cl. G06Q 30/02

(52) U.S. Cl. CPC G06Q 30/0282

(57) ABSTRACT

Systems and method for authenticating reviews are disclosed. One exemplary method includes receiving a request to authenticate a review. The review related to at least one of a commodity and a merchant. The exemplary method further includes identifying a payment account having a first transaction associated with the at least one of the commodity and the merchant. The payment account is associated with the consumer. The exemplary method includes requesting confirmation of a detail of a second transaction to the payment account, the second transaction being different than the first transaction, and issuing, by the server, an authentication for the review, when the detail of the second transaction is confirmed.

### FIELD

The present disclosure generally relates to methods and systems of authenticating reviews, by confirming one or more details of payment accounts associated with consumers' providing the reviews.

### BACKGROUND

This section provides background information related to the present disclosure which is not necessarily prior art.

Consumers are known to purchase commodities, such as products and services, from merchants. The commodities are commonly paid for through use of payment accounts, including accounts linked to credit cards, debit cards, or prepaid cards. Prior to, or after, the purchase of commodities, consumers or others may complete reviews of the commodities, or merchants from which the commodities were purchased. Reviews may include descriptions of commodities, performance evaluations of the commodity, whether good or bad, and various other types of information, which might be useful or useless to subsequent consumers of the commodities or the merchants. Certain merchants, especially Internet merchants, provide reviews of the commodities, accessible through their websites, to inform subsequent purchasers in making purchase decisions. Further, websites are known to provide reviews of both commodities and merchants, so that consumers may compare different merchants, and commodities. Reviews, whether by consumers, or others who have not purchased a commodity, or who have not visited a merchant, are known to influence subsequent consumers.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in authenticating a review of a commodity and/or a merchant;

FIG. 2 is a block diagram of an exemplary computing device, that may be used in the system of FIG. 1;

FIG. 3 is an exemplary method of authenticating a review of a commodity and/or a merchant;

FIG. 4 is an exemplary page suitable for use in the system of FIG. 1 and/or the method of FIG. 3, by a consumer, to provide a review of a commodity and/or a merchant to a review entity;

FIG. 5 is an exemplary page suitable for use in the system of FIG. 1 and/or the method of FIG. 3 to confirm transaction details relating to purchase of the commodity from the merchant, by the consumer, as part of authenticating the review of the commodity and/or merchant by the consumer; and

FIG. 6 is an exemplary page suitable for use in the system of FIG. 1 and/or the method of FIG. 3 to confirm transaction details for the consumer providing the review for the commodity and/or the merchant, as part of authenticating the consumer's review of the commodity and/or merchant.

Corresponding reference numerals indicate corresponding parts throughout the several views of the drawings.

### DETAILED DESCRIPTION

Example embodiments will now be described more fully with reference to the accompanying drawings.

Consumers purchase commodities through use of payment devices, such that transactions for commodities are posted to payment accounts associated with the payment devices. Separately, individuals, whether consumers or others, often provide reviews of commodities and merchants, such that large numbers of reviews are available from review entities, for example, on the Internet, in advertisements, in other publications, etc. The reviews affect, whether positively or negatively, consumers' purchasing decisions as to commodities and merchants. Where reviews are not provided from consumers that purchased the commodity being reviewed, or from the merchant being reviewed, or where the reviews are planted (e.g., are provided by merchants, manufacturers, or other providers of the commodities as self-serving reviews, etc.), the reviews are less indicative of the actual performance, quality, or other traits of the commodity or merchants being reviewed. Systems and methods are provided herein to authenticate reviews of commodities, merchants, or both, through use of payment account details. Such authentication can provide an indication to subsequent consumers reading the reviews that the reviews are, in fact, from prior consumers of the commodities/merchants, and not planted by an interested party.

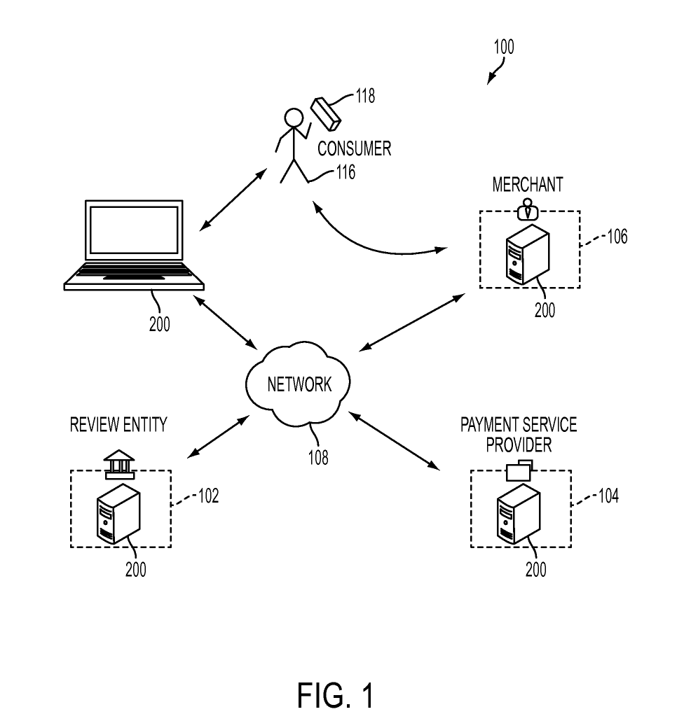

FIG. 1 illustrates an exemplary system 100, in which one or more aspects of the present disclosure may be implemented. For example, the system 100 can be used to authenticate a review of a commodity and/or a merchant, provided by an individual, to thereby confirm that the individual is a consumer who actually purchased the commodity and/or was a patron of the merchant. Although components of the system 100 are presented in one arrangement, in FIG. 1, it should be appreciated that other exemplary embodiments may include the same or different components arranged otherwise, for example, depending on arrangement of payment networks, authentication procedures for approving payment device transactions, identities of and/or interactions between and/or relationships between purchasing entities, merchants, payment service providers, review entities, etc.

The illustrated system 100 generally includes a review entity 102, a payment service provider 104 (e.g., MasterCard®, etc.), and a merchant 106 (e.g., a physical store, an internet-based merchant, etc.), each coupled to network 108. The network 108 may include, without limitation, one or more local area networks (LAN), wide area networks (WAN) (e.g., the Internet, etc.), mobile networks, virtual networks, other networks as described herein, and/or other suitable public and/or private networks capable of supporting communication among two or more of the illustrated components, or any combinations thereof. In one example, the network 108 includes multiple networks, where different ones of the multiple networks are accessible to different ones of the illustrated components in FIG. 1.

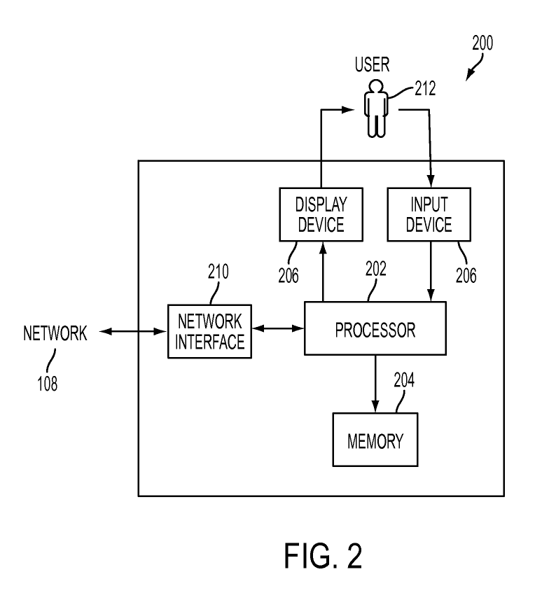

In addition, in the illustrated system 100, the review entity 102, the payment service provider 104, and the merchant 106 include computing devices 200 (as described with reference to FIG. 2) coupled to the network 108. Each computing device 200 may include a single computing device, or multiple computing devices located together or distributed across a geographic region.

The merchant 106 and the payment service provider 104 cooperate, in response to a consumer 116 to complete a payment transaction for a commodity (e.g., a product, a service, etc.). In the exemplary embodiment, the consumer 116 initiates the transaction by presenting a payment device 118 to the merchant 106 (and, in some cases, entering a personal identification number (PIN) associated with the payment device 118). It should be appreciated that the payment device 118 may include any suitable device including, for example, a payment card (e.g., a credit card, a debit card, a pre-paid card, etc.), a payment token, a payment tag, a pass, another enabled device used to provide an account number (e.g., a mobile phone, a tablet, etc.), etc.

In response, the merchant 106 reads the payment device 118 and communicates, via the network 108, an authorization request, including details of the payment transaction, to the payment service provider 104, via one or more acquirer banks (not shown). The payment transaction details may include, for example, an account number, a purchase amount, a time of the purchase, a date of the purchase, other necessary account data included on the payment device 118, other information related to the purchase, etc. The payment service provider 104 stores the authorization request, in memory of the computing device 200, and submits the authorization request to an issuer (not shown) associated with the payment device 118. The issuer provides a response to the authorization request (e.g., authorizing or rejecting the request) to the payment service provider 104, which, in turn, is provided back through the one or more acquirer banks to the merchant 106. The transaction is then completed, by the merchant 106, if permitted by the response.

Separately, the review entity 102 compiles reviews of various commodities offered for sale by the merchant 106 and reviews of the merchant 106. In addition, the review entity 102 may compile reviews of various other commodities and/or various other merchants. The reviews are then made available to consumers, for example, on the Internet, or in advertisements, or in other publications, etc. for use by the individuals in evaluating particular commodities and/or merchants. The review entity 102, as shown in the embodiment of FIG. 1, is a separate review warehouse, such as, for example, an urban city guide (e.g., Yelp®, etc.). Alternatively, in other embodiments, the review entity 102 is incorporated with the merchant 106, the payment service provider 104, or another entity associated with the payment transaction, or the commodities offered for purchase by the merchant 106.

In the illustrated embodiment, after completing the payment transaction with the merchant 106, the consumer 116 contacts the review entity 102 to provide a review (e.g., a written review, a review selected from predetermined options, etc.) of the commodity purchased from the merchant 106 and/or a review of the merchant 106. In so doing, the review entity 102 gives the consumer 116 the option to authenticate the review, either before the review is created or after the review is created. By selection of this option, the review entity 102 communicates, via the network 108, a request to the payment service provider 104 to authenticate the review. While authentication may be optional, in some embodiments, the review entity 102 may require a review to be authenticated (either before the review is completed or after the review is completed) prior to publishing the review. For example, the review entity 102 may automatically communicate a request to the payment service provider 104 to authenticate the review, when the consumer 116 attempts to provide a review.

As part of authenticating the consumer's review (and as part of the request communicated from the review entity 102 to the payment service provider 104), the payment service provider 104 initially confirms, with the consumer 116, details of the payment transaction involving the commodity. This allows the payment service provider 104 to search in memory for the specific transaction details and identify the particular payment account used to purchase the commodity. The payment service provider 104 then confirms, again with the consumer 116, details of the identified payment account to ensure that the consumer 116 is actually associated with the identified payment account (e.g., to reduce the possibility that the consumer 116 is not simply an individual that may have found a receipt for the commodity, etc.). Once the payment transaction and the payment account are confirmed, the payment service provider 104 issues an authentication for the review and communicates, via the network 108, the authentication to the review entity 102. And, the review entity 102 then associates the authentication with the consumer's review, for example, as an icon, etc. included with the published/posted review (e.g., an authenticated post icon, an authenticated user icon, etc.). As can be seen, subsequent consumers are able to quickly identify which of the reviews compiled by the review entity 102, have been authenticated and, thus, are more likely to provide accurate reviews, being from consumers who have previously purchased various commodities and/or who have previously been patrons of various merchants.

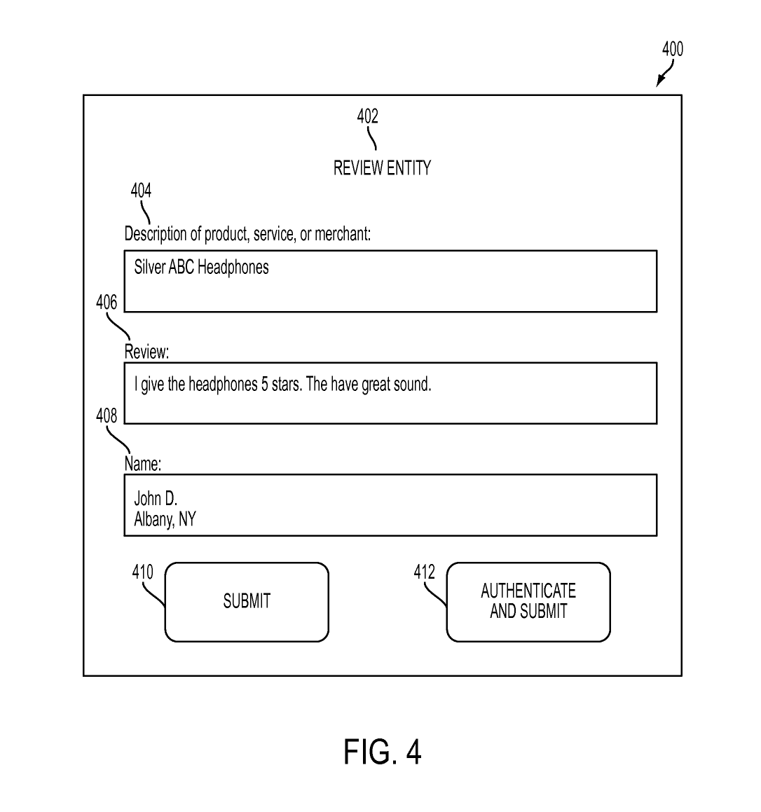

It should be appreciated that various pages (e.g., webpages) may be used in the system 100 of FIG. 1, for example, in connection with the various computing devices 200, to receive the review from the consumer 116 and/or to confirm the details of the payment transaction involving the commodity and/or to confirm details of the payment account associated with the payment transaction. Exemplary pages 400, 500, 600 are shown in FIGS. 4-6, and are described in more detail hereinafter in connection with method 300. With that said, it should be appreciated that the pages 400, 500, 600 in FIGS. 4-6 are merely exemplary, and that a variety of other webpages may be provided, for example, through the review entity 102 and/or payment service provider 104 to facilitate the review process and/or authentication process, with a variety of different arrangements, formats and/or options to display, describe or provide the review and/or the corresponding authentication operations.

In some exemplary embodiments, it is contemplated that the consumer 116 may directly access his/her payment account through the payment service provider 104, via the network 108 and the computing device 200, to view a listing of payment transactions made using the consumer's payment account. In so doing, the consumer 116 may then also be given an option, by the payment service provider 104, to provide a review for a commodity and/or a merchant associated with one or more of the listed transactions. In these embodiments, since the consumer 116 has already accessed the payment account, through the payment service provider 104 (likely using a secure webpage and confidential login credentials), the payment service provider 104 may issue the authentication for any review initiated by the consumer 116 directly from the payment account, and then may communicate the authentication (and any corresponding review, if created at the payment service provider 104), via the network 108, to the review entity 102. In aspects of these embodiments where the review is not created directly at the payment service provider 104 (e.g., prior to authentication, etc.), the review entity 102 may request the review from the consumer 116 upon communication of the authentication by the payment service provider 104 to the review entity 102, and may then associate the authentication with the consumer's review, for example, as an icon, etc. included with the published/posted review.

FIG. 2 illustrates an exemplary computing device 200. For purposes of the description herein, each computing device shown in FIG. 1 is the computing device 200. However, it should be appreciated that each computing device of FIG. 1 should not be understood to be limited to the arrangement of the computing device 200, as depicted in FIG. 2. Different components and/or arrangements of components may be used in other computing devices. In addition, in various exemplary embodiments the computing device 200 may include multiple computing devices located in close proximity, or distributed over a geographic region.

The exemplary computing device 200 includes a processor 202 and a memory 204 that is coupled to the processor 202. The processor 202 may include one or more processing units (e.g., in a multi-core configuration, etc.). The computing device 200 is programmable to perform one or more operations described herein by programming the processor 202 and/or the memory 204. The processor 202 may include, but is not limited to, a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), a solid state disk, and/or a hard disk. The memory 204 may be configured to store, without limitation, payment transaction details, payment account details, for example, for purchasing entities (e.g., consumer 116, etc.), etc. Furthermore, in various embodiments, computer-executable instructions may be stored in the memory 204 for execution by the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

In the exemplary embodiment, the computing device 200 also includes a display device 206 coupled to the processor 202. The display device 206 outputs to a user 212 by, for example, displaying and/or otherwise outputting information such as, but not limited to, pages, reviews, payment transaction details, payment account details, or any other type of data. The display device 206 may include, without limitation, a cathode ray tube (CRT), a liquid crystal display (LCD), a light-emitting diode (LED) display, an organic LED (OLED) display, and/or an “electronic ink” display. In some embodiments, the display device 206 includes multiple devices. As an example, the user 212 may include one or more of the consumer 116, individuals associated with the review entity 102, individuals associated with the payment service provider 104, individuals associated with the merchant 106, etc.

In the exemplary embodiment, the computing device 200 further includes an input device 208 that receives input from the user 212. For example, the input device 208 may be configured to receive any desired type of input from the user 212, for example, as part of creating the review of the commodity and/or the merchant 106, authenticating the review, viewing other reviews, viewing payment transaction details, payment account details, etc. In the exemplary embodiment, the input device 208 is coupled to the processor 202 and may include, for example, a keyboard, a pointing device, a mouse, a stylus, a touch sensitive panel (e.g., a touch pad or a touch screen, etc.), and/or an audio input device. Further, in various exemplary embodiments, a touch screen, such as that included in a tablet or similar device, functions as both the display device 206 and the input device 208.

With continued reference to FIG. 2, the illustrated computing device 200 also includes a network interface 210 coupled to the processor 202. The network interface 210 may include, without limitation, a wired network adapter, a wireless network adapter, a mobile telecommunications adapter, or other device capable of communicating to one or more different networks, including the network 108. In some exemplary embodiments, the computing device 200 includes the processor 202 and one or more network interfaces incorporated into or with the processor 202.

In some exemplary embodiments, computer-executable instructions are stored on non-transitory memory associated with the computing device 200 for execution by the processor 202 to perform the functions described herein. These instructions may be embodied in a variety of different physical or tangible computer-readable media, such as the memory 204 or other non-transitory memory, such as, without limitation, a flash drive, CD-ROM, thumb drive, floppy disk, etc. Computer-readable media may be selectively insertable to and/or removable from the computing device 200 to permit access to and/or execution by the processor 202. In one example, computer-readable media includes a separate optical or magnetic disc that is inserted or placed into an input device associated with the processor 202 and/or the memory 204. In some instances, however, the computer-readable media may not be insertable/removable.

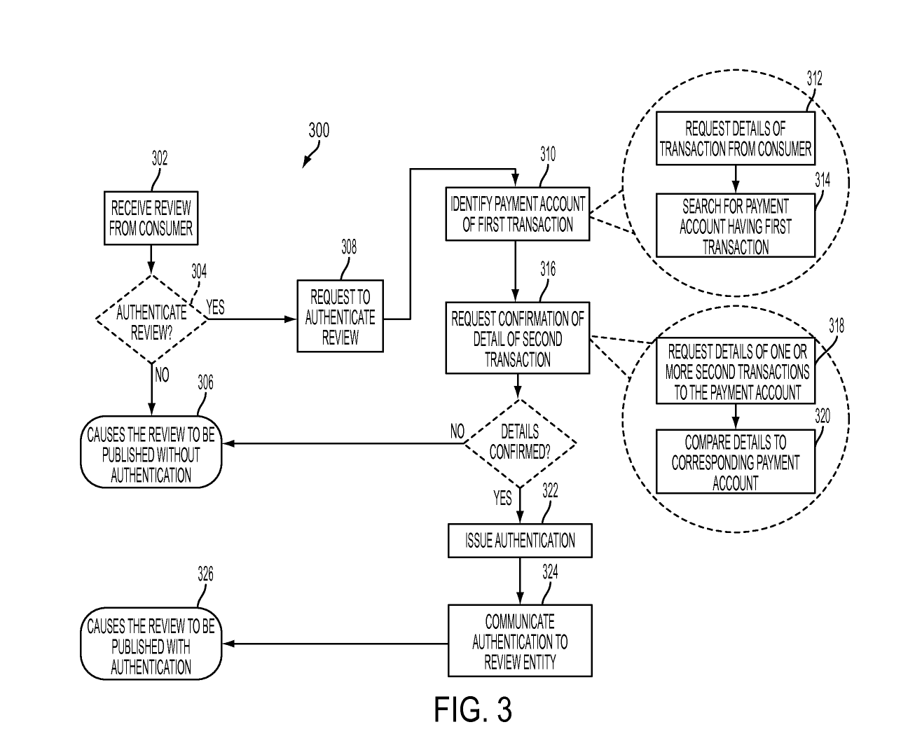

FIG. 3 illustrates exemplary method 300 of authenticating reviews of commodities and/or merchants. The method 300 is described below in connection with the exemplary system 100 and the exemplary computing device 200 previously described. However, it should be appreciated that the method 300 is not limited to the system 100 or the computing device 200, but may be implemented in a variety of different systems and/or computing devices. Likewise, the systems and computing devices described herein should not be understood to be limited to the exemplary method 300, or other methods described herein.

After a consumer 116 purchases a commodity, or patronizes a merchant 106, the consumer 116 may decide to author a review of the commodity, the merchant, or both for a number of reasons, including, for example, experience with the commodity/merchant, an incentive to complete the review, an invitation from the review entity 102, the merchant 106, or another associated with the merchant/commodity, etc. The consumer 116 may initiate the review at the merchant's website, the review entity's website, or another website suitable to accept, facilitate, and/or display reviews of commodities and/or merchants, for example. In other examples, the review may be initiated by telephone, by the consumer 116, the review entity 102, or another. In still other examples, the consumer 116 may receive an email that solicits the review, and provides a link to the review entity's website. The email may be sent from the review entity 102, the merchant 106, the payment service provider 104, or another, based on the consumer's purchase of a commodity, or visit to a merchant, etc. Any number of different factors on the part of the consumer 116, merchant 106, or others may lead to the consumer 116 being solicited for a review.

In the embodiment shown in FIG. 3, the consumer provides a consumer review of the commodity and/or merchant, and the review entity 102 receives the review at 302. In particular, the review entity 102 causes a review page to be displayed at the consumer's computing device. FIG. 4 illustrates an exemplary page 400 available through the review entity 102, for use by the consumer 116 to provide the review to the review entity 102. As shown, the exemplary page 400 includes a general identification 402 of the review entity 102, a text box 404 for describing the commodity being reviewed, a text box 406 for the actual review, and a text box 408 to identify the consumer 116. It should be noted that page 400 is merely exemplary, and that a variety of other webpages may be provided through the review entity 102 to facilitate the review, with a variety of different arrangements, formats and/or options to display, describe or provide the review. For example, in some exemplary embodiments, pages may instead include a list of predetermined review options (e.g., one star, two stars, three starts, four starts, etc.), associated with radio buttons, from which the consumer 116 can select, instead of creating their own written review.

In submitting the review, the consumer 116 is given the option to authenticate, or not authenticate the review. In this exemplary embodiment, page 400 includes a button 410 for submitting the review without authentication, and a button 412 for submitting the review with authentication. Thus, upon completing the review, the consumer 116 submits the review to the review entity 102, either with authentication or without authentication (e.g., using the appropriate button). The consumer 116 may select to submit the review without authentication, for example, when the commodity was purchased with cash, or when the details for the transaction are not available to the consumer 116, or in other cases where authentication is unavailable. Or, the consumer 116 may select to submit the review without authentication when he/she simply wants to provide the review to the review entity 102, but does not want to take the additional actions to authenticate the review.

In response to the submission, the review entity 102 determines at 304 whether the review is to be authenticated or not. If submitted without authentication, review entity 102 causes the review to be published without authentication at 306. The review may be published to one or more different websites or forums, or simply stored, in memory, as part of website resources, databases, or other sources from which one or more websites or forums retrieve reviews. When published, the review appears to the consumer without indication of authentication.

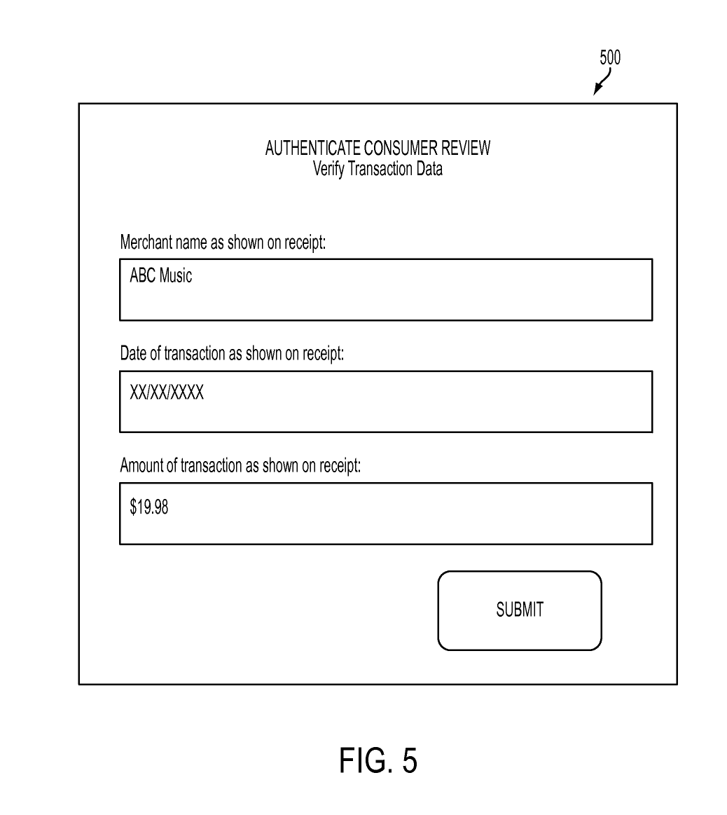

If the review entity 102 determines the review was to be authenticated at 304, it requests, via the network 108, the payment service provider 104 to authenticate the review at 308. As a result, the payment service provider 104 receives the request. In response, the payment service provider 104, in this embodiment, identifies, at 310, the payment account of the first transaction at 310. The first transaction is the transaction, which is the subject of the review. In other words, the first transaction includes the commodity being reviewed, or the merchant being reviewed, or both. To identify the payment account, the payment service provider 104 may, in this embodiment (indicated by the dotted lines in FIG. 3), request at 312 details of the first transaction associated with the at least one of the commodity and the merchant. Details may include, for example, one or more of a name of the merchant 106, the commodity purchased, a location of the first transaction, a date of the first transaction, a time of the first transaction, an amount of the first transaction, an identification of a type of payment device 118 used, etc. FIG. 5 illustrates an exemplary page 500 for use by the payment service provider 104 to request the specific details of the payment transaction. As shown, the exemplary page 500 includes a list of questions relating to the payment transaction, and corresponding editable text boxes for the consumer 116 to provide responses. In response, the payment service provider 104 receives the requested details of the first transaction. In at least one embodiment, the request from the review entity 102 includes details about the first transaction, such that the payment service provider is not required to request additional details about the first transaction from the consumer 116, or the review entity 102. Such detail may include, for example, an account number for the payment account, the commodity purchased, an amount of the first transaction, an identification of a type of payment device 118 used, etc.

The payment service provider 104 then searches at 314, in memory 204, for the payment account, based on the details of the first transaction. The search may be based on any of the information received from the consumer 116, or the review entity 102 as part of the request for authentication or otherwise, including the example details related to the first transaction described above. In at least one example, where the review is directed to a commodity, the payment service provider 104 then verifies a search result based on the merchant category codes (MCC) for the merchant and/or the commodity being reviewed. The search, in this embodiment, results in an identified payment account for the payment transaction.

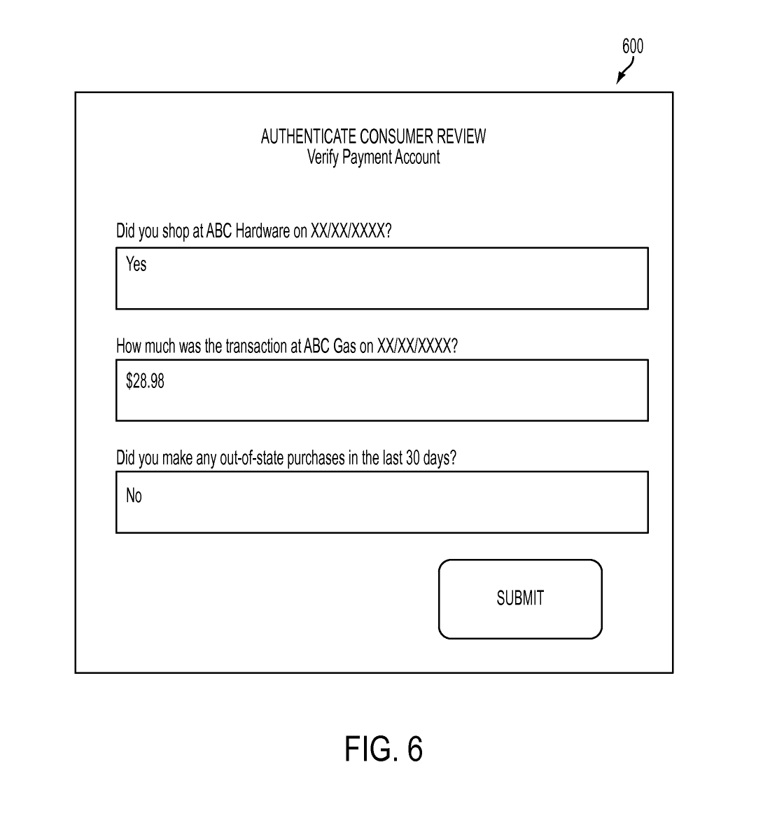

After the payment account is identified at 310, the payment service provider 104 may request confirmation, at 318, of at least one detail about one or more other (e.g., a second, etc.) transactions to the payment account. The payment service provider 104 may request confirmation of one or more details about one transaction different than the first transaction, or may request one or more details about multiple transactions different than the first transaction. The number of details to be confirmed may be changed in a variety of embodiments, depending on, for example, the degree of confidence desired that the consumer 116 is the holder of the payment account, ease of authentication, etc. As shown in FIG. 3, in this exemplary embodiment, requesting confirmation 316 may include requesting from the consumer 116, at 318, details of at least one additional transaction associated with the payment account including, for example, one or more of a date of a particular purchase at a particular merchant, an amount of a particular purchase at a particular merchant, a location (e.g., city, state, country, etc.) of a particular purchase, etc. FIG. 6 illustrates an exemplary page 600 for use by the payment service provider 104 in posing questions to the consumer 116 to request the specific details of the payment account, and in particular one or more second transactions. As shown, the exemplary page 600 includes a list of questions relating to at least one second transaction associated with the payment account, different than the first transaction, and corresponding editable text boxes for the consumer 116 to provide responses. Alternatively, the page 600 may include radio buttons associated with predefined response options to the list of questions (e.g., ‘yes’ and ‘no’ options, etc.).

The payment service provider 104 then compares, at 322, the specific details provided by the consumer 116 to the corresponding payment account data stored in the memory 204, via the computing device 200, and, when they match, confirms the details of the payment account (and, in some aspects, also associates/connects the payment transaction to the payment account). Details of the identified payment account may be confirmed by the review entity 102, with the consumer 116, in a variety of different ways.

Once details of the one or more second transactions are confirmed, the payment service provider 104 issues an authentication for the review, at 322, and communicates, via the network 108, the authentication to the review entity 102, at 324. And, in turn, the review entity 102 causes the review to be published with authentication at 326. When published on one or more websites, or forums, the review would then be displayed with an icon and/or symbol, thereby indicating the consumer review had been authenticated by the review entity 102 and/or the payment service provider 104. It should be understood that potential consumers (or other interested individuals) can then quickly identify which of the numerous reviews compiled by the review entity 102, and available to the consumers, have been authenticated and, thus, are from actual consumers 116 who have previously purchased the commodities and/or patronized the merchants.

While in the illustrated method 300, the review entity 102 allows the consumer 116 the option to submit the review with authentication or without authentication. In other exemplary embodiments, the review entity 102 may only accept authenticated reviews. Here, for example, the consumer 116 will not be given the option to authenticate the review. Instead, when the review is initiated (and either before the review is completed or after the review is completed), the review entity 102 automatically communicates, via the network 108, a request to the payment service provider 104 to authenticate the review.

It should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following exemplary operations, or any other operation described herein: (a) receiving, at a server, a request to authenticate a review, the review related to at least one of a commodity and a merchant, (b) identifying, at the server, a payment account having a first transaction associated with the at least one of the commodity and the merchant, the payment account associated with the consumer, (c) requesting confirmation of a detail of a second transaction to the payment account, the second transaction being different than the first transaction, and (d) issuing, by the server, an authentication for the review, when the detail of the second transaction is confirmed.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” or “included with” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, sections, and/or operations, these elements, components, regions, layers, sections, and/or operations should not be limited by these terms. These terms may be only used to distinguish one element, component, region, layer, section, or operation from another element, component, region, layer, section or operation. Terms such as “first,” “second,” and other numerical terms when used herein do not imply a sequence or order unless clearly indicated by the context. Thus, a first element, component, region, layer, section, or operation discussed herein could be termed a second element, component, region, layer, section or operation without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of authenticating a review provided by a consumer, the method comprising:
receiving, at a server, a request to authenticate a review, the review related to at least one of a commodity and a merchant;
identifying, at the server, a payment account having a first transaction associated with the at least one of the commodity and the merchant, the payment account associated with the consumer;
requesting confirmation of a detail of a second transaction to the payment account, the second transaction being different than the first transaction; and
issuing, by the server, an authentication for the review, when the detail of the second transaction is confirmed.

2. The method of claim 1, wherein identifying the payment account includes requesting details of the first transaction associated with the at least one of the commodity and the merchant.

3. The method of claim 2, wherein identifying the payment account further includes receiving, from the consumer, the details of the first transaction and searching, in a memory of the server, for the payment account based on the details of the first transaction.

4. The method of claim 3, wherein the details of the first transaction include at least one of a name of the merchant involved in the first transaction, a location of the first transaction, a date of the first transaction, a time of the first transaction, and an amount of the first transaction.

5. The method of claim 2, wherein requesting details of the first transaction includes causing to be displayed, at a computing device associated with the consumer, a page including at least one question regarding the first transaction.

6. The method of claim 1, wherein requesting confirmation of the detail of the second transaction includes causing to be displayed, at a computing device of the consumer, a page including at least one question related to the second transaction.

7. The method of claim 1, wherein requesting confirmation of the detail of the second transaction includes posing at least one question, to the consumer associated with the first transaction, related to an amount or a location of the second transaction.

8. The method of claim 7, wherein the second transaction includes multiple transactions to the payment account; and
wherein requesting confirmation of the detail of the second transaction includes requesting confirmation of a detail for each of the multiple transactions.

9. The method of claim 1, wherein issuing the authentication for the review includes communicating the authentication to a review entity, for publication with the review.

10. A system for authenticating reviews of commodities and/or merchants, the system comprising:
a memory configured to store transactions to a payment account, the transactions including a first transaction and a second transaction, the first transaction associated with at least one of a commodity and a merchant;
a processor configured to:
receive a request to authenticate a review for the at least one of the commodity and the merchant;
identify the payment account based on details of the first transaction,
confirm details for the second transaction stored for the payment account; and
issue an authentication for the review, when the details for the second transaction are confirmed.

11. The system of claim 10, wherein the processor is configured to receive details related to the first transaction, via a network interface coupled to the processor, and to search, in the memory, for the payment account based on the received details related to the first transaction, to thereby identify the payment account.

12. The system of claim 10, wherein the request includes details related to the first transaction, and the processor is configured to identify the payment account based on the details included in the request.

13. The system of claim 12, wherein the details of the first transaction include one or more of a name of the merchant associated with the first transaction, a location of the first transaction, a date of the first transaction, a time of the first transaction, an amount of the first transaction, and an identification of a payment device used in the first transaction.

14. The system of claim 10, wherein the request includes an account number for the payment account, and the processor is configured to identify the payment account based on the account number.

15. The system of claim 10, wherein the processor is further configured to associate the authentication with the review.

16. The system of claim 10, wherein the processor is configured to cause to be displayed, at a computing device of the consumer, a page including at least one question related to the second transaction.
